(19) United States
(12) Patent Application Publication
(10) Pub. No.: US 2007/0067342 A1
(43) Pub. Date: Mar. 22, 2007

(54) Calendar based image display system

(76) Inventors: Nancy Haralambopoulos, Rochester, NY (US); Constantine Haralambopoulos, Rochester, NY (US); Marc A. Rossi, West Palm Beach, FL (US)

Correspondence Address: ROSSI, KIMMS & McDOWELL LLP., P.O. BOX 826, ASHBURN, VA, 20146-0826, US

(21) Appl. No.: 11/232,462

(22) Filed: Sep. 21, 2005

(51) Int. Cl. G06F 7/00

(52) U.S. Cl. 707/104.1

(57) ABSTRACT

A calendar-based image display system is disclosed. The calendar-based image display system uses the current calendar date and/or time to select an image to be displayed on the display screen of a computer, cellular telephone, personal digital assistant, or similar electronic device. Images are stored in a database that may reside within the user's electronic device, or at a remote location. The image displayed may function as a screen saver, a wall paper, or an auxiliary image on the display screen. The calendar-based image display system may be used to display the image of a person whose birthday falls on the current date. Alternatively, it may be used to display an image of a saint whose feast day is on the current date. It may also be used to indicate scheduled activities.

### BACKGROUND OF THE INVENTION

This invention relates in general to an image display system for electronic devices. In particular, the system provides for the display of an image that is based on a current calendar date.

The use of electronic and communication devices such as computers, cellular telephones, personal digital assistants, and digital music devices has rapidly expanded over the past decade. As electronic devices continue to decrease in size and increase in data storage and processing capability, they will continue to grow in popularity among the general public. The appeal of computers, wireless communication devices, and other electronics, and the respective capabilities and convenience they offer, is universal, cutting across generational, educational, professional, and cultural lines in today's world economy.

A majority of the aforementioned devices have a display screen, whether it be large—as in the case of a computer monitor—or small—as in case of a display screen on a cellular telephone—. While the display screens are primarily used to display software applications related information, the display screens may also be used to display commercial screen savers, personal digital photographs, or a digital wallpaper that serves as a background for software applications. Screen savers, for example, appear on a display screen when the device has been idle for period of time. When a user touches a key or otherwise accesses the device, the screen saver disappears and is replaced by a user interface screen. By contrast, a wallpaper serves as a background for the user interface screen so is visible along with icons or text representing user options or information. Generally, a wallpaper covers the entire screen area. However, smaller images may also displayed on the display screen, appearing along with program icons, menu selections, or the like.

Generally, display images are used for aesthetic purposes, adding a touch of color, humor, or whimsy to an otherwise impersonal display screen. In most instances the one or more images that comprise the screen saver or wallpaper are selected from a commercial software compilation of a finite number of images, or from a user-compiled collection of digitized images. Commercial software may contain images that are related by subject, e.g. wild animals, nature scenes, pets, sports; or may contain a random combination of unrelated images. In some cases, additional images are periodically downloaded from external sources to expand the number of images available for display. Image subjects of user-compiled collections run the full gamut of possibilities since users may include their own personal images as well as images obtained from commercial sources and the Internet. Usually a single image is selected for display purposes, or multiple images are displayed on a rotational basis, with display duration and period of rotation either preformatted by the software designer, or selected by the user. Image size is variable, ranging from dimensions that cover the entire display screen area to parameters that cover only a small portion thereof.

The advantage of utilizing a screen saver, wallpaper, or similar program to display images is that the images appear automatically, without requiring the operator to remember or to take the time to specifically select an image option each time the device is turned on. With such display programs, an image is always available to the operator, without any additional operator input. Once a particular screen saver, wallpaper, or other image is initially designated, it remains in effect until changed by the operator.

Although adequate for aesthetic purposes, current screen savers, digital wallpapers, and their ilk are not designed to provide timely information. Images may be accompanied by informative remarks, for example an image of a wild bear may be annotated with information regarding species and habitat. However, that information may not be of particular interest or use to the operator. Furthermore, the information is static, appearing every time the image is displayed. Depending on the number of images available for display, the display duration, and the rotational period, the same information may be permanently displayed, temporarily displayed over multiple days, or periodically displayed multiple times per day. Textual information appended to an image, while readable in the context of a screen saver, if displayed in a background wallpaper may be difficult to read if displayed as a background wallpaper in conjunction with a text-containing user interface screen. Furthermore, the wallpaper text may have a detrimental effect on the legibility of the user interface display.

With the ever expanding public use of and reliance on electronic devices, the ability to convey useful and timely information via a visual image would be beneficial for a large number of consumers. There is a need for an image display system that imparts useful information in the context of a visual image that can be easily observed, recognized and assimilated by the user. An image displayed as a background does not interfere with and is not made incomprehensible by superimposed text. Thus, information conveyed in the context of an image can be imparted to the user regardless of whether the image is used as a screen saver, appearing when the operator is idle, or as a wallpaper that is present concurrent with device use, or simply a smaller image that appears on the screen.

There is a need for an image display system that provides timely information of interest to the user without a user input requirement each time the device is turned on. As technology advances, consumers expect shorter device start up times, customized features, and streamlined operations. While desirous of the information available in a display image, an operator would find tiresome and redundant a requirement that an image must be requested each time the device is used. Furthermore, should a user fail to fulfill the input requirement, either due to insufficient time or simple forgetfulness, the user is deprived of the information which he or she has deemed pertinent.

### SUMMARY OF THE INVENTION

The invention provides a system by which useful information is conveyed on a timely basis to an operator via a visual image appearing on a display screen of an electronic device. It is an object of this invention to provide user requested information via an image that is readily observed, recognized and assimilated by the user, whether the image appears in the foreground or the background of the display screen. Thus, the user has access to the desired information regardless of image size or form.

It is a further object of this invention to provide user requested information on a continual basis without a daily user input requirement. The displayed images are customized for the individual user so as to convey information specifically requested by the user; irrelevant, undesired information is not displayed. After initial installation by the operator no further operator input is required unless the user desires to alter his or her initial selection. The invention will automatically display a visual image, ensuring that the device operator is never deprived of the information as a result of failing to actively request an image to be displayed.

It is a further object of this invention to provide user requested information on a timely basis. The image selected for display is determined by the current calendar date. Accordingly, the image for February first may or may not differ from the image displayed on February second. For example, if the operator desired the image display system to produce images related to birthday information, an image of the person whose birthday is February first would be displayed on February first but not on February second. In contrast, if an operator desired the calendar-based image display system to produce images related to a season, the images displayed on both dates may or may not be the same since they are both days in the winter season. Winter season images, would however, differ from the images displayed during the spring season.

### BRIEF DESCRIPTION OF THE DRAWINGS

The invention will now be described with reference to certain preferred embodiments thereof and accompanying drawings, wherein:

FIG. 1 is a schematic block diagram depicting one embodiment of the calendar based image display system;

FIG. 2 depicts a further embodiment of the calendar based image display system; and

FIG. 3 depicts yet a further embodiment of the calendar based image display system.

### DETAILED DESCRIPTION OF THE PREFERRED EMBODIMENTS

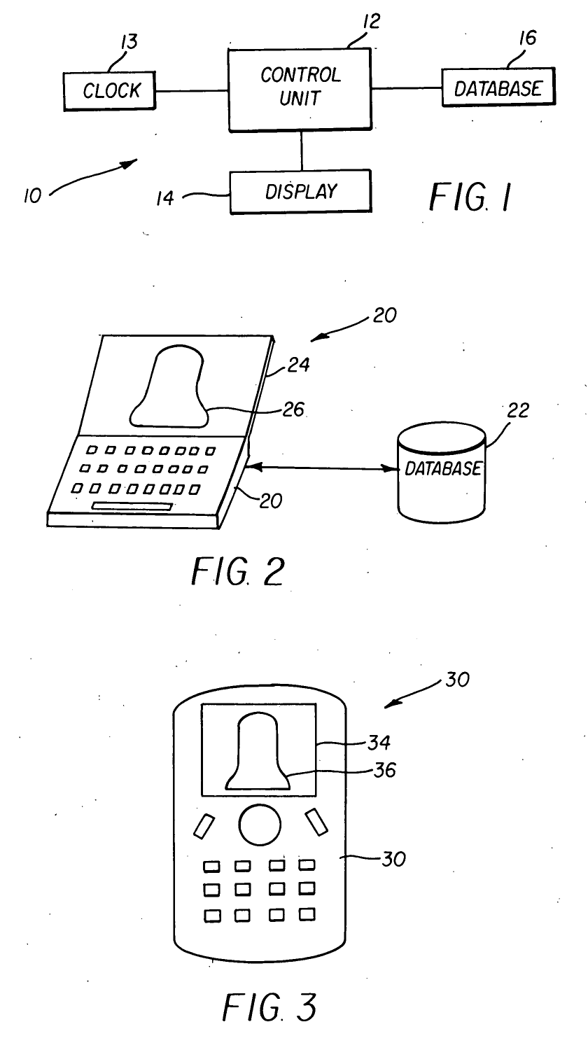

FIG. 1 is a schematic block diagram depicted the operation of the present invention. A control unit 12 uses a calendar date or time determined by a clock 13 to select an image from a database 16. The image is then displayed on a display screen 14. Accordingly, the image displayed on the display screen 14 is linked to an image from the database 16 based on a calendar date or time.

In one embodiment, the calendar-based image display system is computer based, as shown in FIG. 2. Referring to FIG. 2, there is a laptop computer 20 equipped with the present invention. A display screen 24 is shown with an image 26 displayed. In this embodiment the computer CPU functions as the control unit 12 and the system clock as the clock 13. The present invention uses the date and/or time produced by the computer clock to select an image 26 to be displayed on display screen 24. The image 26 may be stored within the computer's memory or at a database 22 remote from the computer 20. In the case of remote storage, the computer 20 is linked to the database utilizing convention network technology that may be either hard wired or wireless. The type or character of image displayed is customized by the user. For example, the user may desire that if the current date corresponds to a birthday of a relative, associate, or celebrity, an image of that person is displayed. In this example, if the current date corresponds to a birthday date, the calendar-based image display system identifies the image associated with that birthday and causes it to be displayed on the display screen 22. If the current date does not correspond to a specifically identified birthday, a default image is displayed, or alternatively, no image is displayed.

Perhaps the user is a member of a faith community in which each calendar day is a feast day for a particular saint or holy person recognized by the user's religious community. In this case the image produced by the calendar-based image display system for each date is unique for that particular date. Throughout the calendar year, no image is displayed on more than one day because each saint has only one feast day. Alternatively, if the user selects images based upon season of the year, an image associated with the spring season may be repeated during that season. Likewise, images associated with scheduled activities may appear on multiple days over the course of the year. For example, an operator may use the present invention to produce images based on the activities scheduled for each day of the week. If music lessons are on Tuesdays, then an image of a musical note appears on Tuesday, while a basketball, indicating basketball practice, is produced each Friday.

There are several methods by which the calendar-based image display system operates. In one embodiment, as described above, the calendar-based image system utilizes a database of digitized images resident within the computer. For example, suppose the calendar-based image display system is used to select images based on feast days of religious figures. Images of the saints are stored in a database and associated with particular calendar dates. Using the date supplied by the clock, the controller, in this case the computer CPU, extracts from a computer database an image of the saint whose feast day is celebrated on the current date. In a preferred embodiment, information regarding date and image associations is encoded on a digital disk which is loaded into the computer and subsequently stored in memory. Alternatively, an operator may want to personally generate his or her database by inputting images to computer via scanners, digital cameras, cell phones or other compatible devices.

In an alternative embodiment, the image database is not stored in the computer. Instead, the image database exists at an external site, for example, a worldwide web site accessed via the Internet. In this case, the calendar-based image display system operates to display the image received from an external site. When the computer 20 is turned on and Internet service accessible, a query is automatically generated to a previously identified Internet address. The query contains calendar date information from the computer 20. In one embodiment, the computer 20 date information is used to select an image associated with that date and stored at the external site, to be downloaded. In an alternative embodiment, information identifying the image associated with a particular date is stored in the memory of computer 20, but the actual digital image is not. The identification information is communicated to the external database site via a query from computer 20. The image identified in the query is then downloaded. Once an image is obtained and displayed, a new image is not requested until the date changes. Communication between the computer 20 equipped with the calendar-based image display system and the external database is implemented by wired or wireless means as mentioned above.

A further embodiment of the invention encompasses a combination of the resident and external databases. Rather than being downloaded daily, image information is downloaded from an external site on a weekly, monthly or other timely basis. The information downloaded is then stored in the memory of computer 20 and accessed daily to produce an image 26.

In the embodiments of the present invention discussed above, only one image is associated with a particular calendar date and/or time. However, there may be instances where multiple images are associated with a particular date. For example, two people may have birthdays on the same date. In the case of the calendar-based image display system used to indicate scheduled activities, more than one activity may be scheduled. Or, if used to display images of saints on feast days, perhaps multiple images are available for a particular saint. The invention may be practiced in several ways; for example the calendar-based image display system may rotate the images over the course of the calendar day, show the images concurrently, or display a single image.

Referring to FIG. 2, it is observed that image 26 covers a large portion of display screen 24. In this embodiment of the invention, the image 26 functions as a screen saver, no text or menu icons appear in conjunction with image 26. However, in an alternative embodiment the image 26 is displayed in the background, as a wallpaper, with text superimposed on the image. The presence of text does not prevent the image from being recognizable. Consequently, the user is reminded of the information each time he or she views the display screen 24. In a further embodiment, an image occupying a smaller portion of the display screen is displayed, appearing concurrently with other user interface graphics, icons, or text.

FIG. 3 depicts yet another embodiment of the present invention. In this example, a cellular telephone 30 is equipped with a calendar-based image display system. Display screen 34 presents an image 36. In this exemplary embodiment, the image 36 functions as a screen saver, appearing when the cell phone is turned on, but in an idle state. The database of images is stored in the memory (not shown) of the cell phone 30. The cell phone microprocessor functions as a controller and uses the date calculated by the internal clock to select an image 36 to be displayed on display screen 34.

In an alternative embodiment, the image information is not resident within the cell phone, but is stored in a database at an external site. The images may be communicated to the cell phone microprocessor via the Internet or by text and image communications conducted over telephone communication links. A cell phone provider or Internet provider, for example, may set up a service to download images on a periodic basis to a user.

Although shown as a screen saver in FIG. 3, image 36 may also be used as a wallpaper on display screen 34. If functioning as a wallpaper, user interface icons, options, and text appear superimposed on the background image, and the image is visible when the cell phone is in use and not idle. In one embodiment, the image 36 is similar in proportion to other icons on the display screen 34; however the invention can be practiced with other image sizes as well.

Computer-based and cellular telephone based embodiments of the present invention are discussed above. However, the calendar-based image display system is also compatible with other electronic devices, such as personal digital assistants (PDAs), video game systems, etc. Accordingly, all modifications attainable by one versed in the art from the present disclosure within the scope and spirit of the present invention are to be included as further embodiments of the present invention. For example, while a separate clock and control unit are illustrated in the schematic block diagram, it will be understood these elements can be implemented as a single component.

What is claimed is:

1. A calendar-based image display system comprising:
a clock;
a database containing a plurality of images;
a display screen; and
a control unit coupled to the clock, database and display screen;
wherein the clock supplies a current calendar date to the control unit and the control unit selects an image from the database for display on the display screen in response to the received current calendar date.

2. A calendar-based image display system as described in claim 1, wherein the control unit comprises a central processing unit of a computer.

3. A calendar-based image display system as described in claim 2, wherein the database is stored in the computer.

4. A calendar-based image display system as described in claim 2, wherein the database is stored at a location external to the computer.

5. A calendar-based image display system as described in claim 1, wherein the control unit is a control processor of a cellular telephone.

6. A calendar-based image display system as described in claim 5, wherein the database is stored in the cellular telephone.

7. A calendar-based image display system as described in claim 1, wherein the control unit is a control processor of a personal digital assistant device.

8. A calendar-based image display system as described in claim 7, wherein the database is stored in the personal digital assistant device.

9. A calendar-based image display system as described in claim 1, wherein the image is displayed on the display screen as a screen saver.

10. A calendar-based image display system as described in claim 1, wherein the image is displayed on the display screen as a wallpaper.

11. A calendar-based image display system as described in claim 1, wherein the database consists of images of religious figures.

12. A calendar-based image display system as described in claim 1, wherein the image selected is that of a saint whose feast day falls upon the current calendar date.

13. A calendar-based image display system as described in claim 1, wherein the image selected by the control unit is that of a person whose birthday falls upon the current calendar date.

14. A calendar-based image display system as described in claim 1, wherein the image selected by the control unit is one that reflects the current season.

15. A calendar-based image display system as described in claim 1, wherein the image selected by the control unit is one that indicates an activity scheduled for the current calendar date.
